(19) United States
(12) Patent Application Publication
(10) Pub. No.: US 2016/0145008 A1
(43) Pub. Date: May 26, 2016

(54) SIDE FOLD SACK WITH ROLL BOTTOM

(71) Applicant: WINDMOELLER & HOELSCHER KG, LENGERICH (DE)

(72) Inventor: Uwe KOEHN, Osnabrueck (DE)

(73) Assignee: WINDMOELLER & HOELSCHER KG, LENGERICH (DE)

(21) Appl. No.: 14/805,128

(22) Filed: Jul. 21, 2015

Related U.S. Application Data
(63) Continuation of application No. 12/659,351, filed on Mar. 4, 2010, now abandoned.
Application No. 12/659,351 is a continuation of application No. 11/136,724, filed on May 25, 2005, now abandoned.

(51) Int. Cl. B65D 30/20; B31B 3/64; B31B 1/90; B31B 1/64

(52) U.S. Cl. CPC B65D 31/10; B31B 1/64; B31B 3/64; B31B 1/90

(57) ABSTRACT

A side fold sack of polyolefin material that includes a tubular segment having side folds between front and rear walls of the tube. The bottom of the sack exhibits at least one fold of the tubular segment made at 180° about an axis which is generally transverse to the side folds. At least part of the folded area is covered with a label that provides support to the bottom of the sack.

This application is a continuation application of co-pending application Ser. No. 12/659,351, filed Mar. 4, 2010, which was a continuation application of Ser. No. 11/136,724, filed May 25, 2005, and hereby claims the priority thereof to which it is entitled.

### BACKGROUND OF THE INVENTION

1. Field of the Invention

The invention relates to sacks made from polyolefin material, which exhibit features including an area of a tubular segment, with front walls and side walls of the sack, whereby the side walls exhibit side folds, and a bottom area at an end of the area of the tube segment, which exhibits at least one fold of the tube piece material made at 180° about the axis, which runs essentially transversely to the side folds.

2. Description of the Related Art

Such type of sacks are known. Of these, sacks made from polyolefin material are particularly “firm” or shape-sustaining and, for this purpose, the polyolefin fibers are in general textured and oriented mostly monoaxially, that is along their longitudinal axis. These fibers are often entwined into flat sheets, from which tubes are later produced. However, the fibers can be processed directly to round tubes. This polyolefin material and its properties are well-known and are explained in, besides other publications, WO 95/30598. Further processing of this material requires in-depth know-how.

For instance, DE 101 06 289 A1 shows such a sack. Among the disadvantages of the sacks fabricated with this type of simple fabrication procedure is that the bottom fold opens up when the filled sack is stacked and the fold is exposed directly to mechanical load. Such mechanical load can be created by another heavy, filled sack being dragged over this bottom fold, leading to breaking open of the fold. Therefore, the underlying problem of the invention was to propose a sack, in which the bottom area exhibits greater durability. This problem is solved by a side fold sack made from polyolefin material and including a tubular segment, with front walls and side walls of the sack, whereby the side walls exhibit side folds, and a bottom area at an end of the area of the tubular segment. The bottom area exhibits at least one fold of the tube piece material made at 180° about the axis, which runs essentially transversely to the side folds. According to the present invention, a label covers at least part of the folded area to provide support to the bottom of the sack.

### SUMMARY OF THE INVENTION

Among the other advantages of a sack according to the present invention is that, due to the presence of the bottom cover, the filled sack readily assumes a cuboid or a box-shaped form. Sacks made from polyolefin material and provided with a label are particularly shape-sustaining due to the monoaxial orientation of the polyolefin fibers.

Thus, because the polyolefin fibers are in general textured and oriented mostly monoaxially, that is along their longitudinal axis, it is necessary to follow certain processing steps during the welding of these sacks, in order to not lose the shape-retaining firmness of the oriented material. The aforementioned publication in the Description of the Prior Art section also contains the details about that topic as well as about the used temperature ranges.

A heat induced seaming procedure in connection with the processing of the sack according to the invention is especially of advantage. Heat induced seaming means here a method of bonding, which requires supply of heat. That is, even a gluing method, which is carried out with temperature-dependent adhesives also belongs to a heat induced bonding method. The same applies to any other type of processing of the extrudates.

Especially advantageous among heat induced seaming methods are the joint welding methods, in which the polyolefin fabric is bonded. Thereby, attention must be paid, as mentioned, that the firmness or shape-retaining characteristic of the polyolefin fabric does not get impaired due to monoaxial orientation of the macromolecules in polyolefin bands.

A further advantageous possibility in the processing of this material lies in that, the coating, which is often made on polyolefin band tissues, is welded. The fabric is often coated in order, in particular, to make the tissue more tight against leakage when filled with pulverizable material.

The sack according to the present invention exhibits a bottom fold, which is made about an axis, which is essentially transverse to the axis of the tubular segment or an area of tubular segment. Such a fold or a rolling is not easy to make. Even this fold or the rolling contributes to the subsequent box-like shape of the filled up sack and is therefore of special advantage. With a double fold, not only the stability, but also the sack's tightness in the bottom area is increased considerably and to a surprisingly remarkable extent. The double fold leads to a still stronger bottom, which also supports the box-like shape of the sack especially in conjunction with the label. During the deposition of the label, care must be taken that at least parts of the bottom fold are covered with the label, so that the fold is supported by the label. Depending on the label, however, it can be adequate, if most of the areas remain unsupported and if the labels, for example, in the form of adhesive bands, cover only some parts of the areas of the fold.

For the fabrication of the sacks according to the present invention, such tubular segments are suitable, which exhibit straight and/or staggered cuts. Sacks according to the invention with straight cuts are especially simple to fabricate. A preferred area of application of the sacks according to the invention lies in the storage and transport of bulk goods, especially of powder-like goods. In this area of its application, sacks, which also exhibit a box-like form, are common, but which are provided with a folded block bottom. Manufacture of such sacks is very elaborate. Common in this area of application are also cross bottom sacks.

In the context of the present publication, bonding process is used to mean anything, in which materials are joined with each other. Explicitly mentioned already were the bonding and gluing processes, as well as joints of plastic parts with extrudates. Various materials can be used as labels, depending on the requirements in regard to the stability of the sack. These materials can be the same as or different from the material of the sack or the material of the tubular segment. In case of particularly high loads, olefin fabrics can be used. Again, here too, the modalities involved in making the joints, or the processing conditions recommendable in the processing of polyolefin fabrics, should be adhered to. In that context, reference is made again to the publication WO 95/30598. Especially advantageous thereby in the fabrication of the seams is, if the outer layer of the tube or the sack material is joined by melting. The heat necessary for that can thereby be supplied by means of heated air, which is blown on the seams to be jointed.

### BRIEF DESCRIPTION OF THE DRAWINGS

FIG. 1 is a perspective view of a tube or segment of the tube in the fabrication of a sack according to the invention.

FIG. 2 is a side view of a segment of the tube, in which an end is rolled inwards.

FIG. 3 is a top view of an end of a sack according to the invention.

FIG. 4 is a side view of an end of a sack according to the invention.

### DETAILED DESCRIPTION OF THE PREFERRED EMBODIMENTS

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

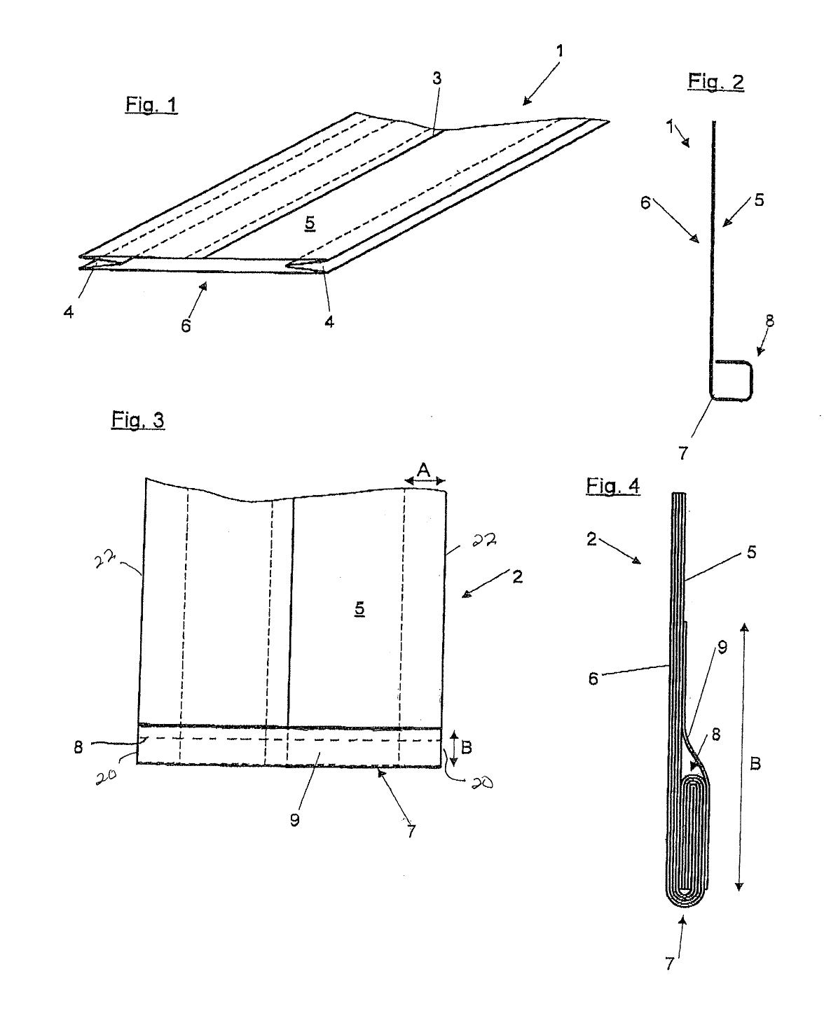

FIG. 1 shows a perspective view of a tube 1 or a tubular segment, which is suitable for the fabrication of a sack 2 according to the invention. In the exemplary embodiment, the tube 1 exhibits a longitudinal seam 3. As a rule, the tubes are in general fabricated with such a lengthwise seam from a flat sheet. Alternatively, the tube 1 can also be of a round shaped material, so that no lengthwise seams are there. The tube 1 shown in FIG. 1 exhibits side folds 4, made with depth A (see FIG. 3), between the front wall 5 and the rear wall 6 of the tube 1.

One step in the fabrication process of the sacks 2 according to the invention is illustrated in FIG. 2. About one axis (7), which runs transversely to the lengthwise seam 3 and lies in the plane parallel to the walls 5 and 6 of the tube, the lower end of the tube 8 is folded or rolled. Thereby, the folded end 8 of the tube comes to lie against the front wall 5 of the tube 1 or the sack 2 (as shown) or on the rear wall 6 (not shown). In each, two layers, which are laid one above the other by folding over or rolling the bottom of the bag twice, can be connected through an appropriate bonding process. As shown in FIG. 3, an outer side edge 20 of the bottom folded region is linearly aligned with an outer side edge 22 of the sack. Therefore, a length of the bottom folded region 8 as measured along the transverse axis between the outer side edges 20 is the same as a length of the sack when the sack is also measured along the transverse axis between the outer side edges of the sack.

After the rolling up or folding of the end 8, a label 9 is connected with the folded end 8, and on the wall, on which the fold or the roll lies. In the example shown in FIGS. 3 and 4, the label 9 is connected with the lower end 8 and with the front wall 5. The label 9 extends over the entire length of the sack 2 or the tube 1. In the shown exemplary embodiment, the width B of the label 9 is somewhat smaller than the depth A of the side folds. If the width of the label 9 is smaller than or equal to the depth A and the side edge of the label 9 is arranged near the fold—or the axis (7) of the roll, then the label 9 lies exclusively at the bottom area of the sack, if it assumes, for example due to filling, a block-like shape. In that case, the bottom is also very resilient against mechanical loads, even when the sack is filled up. In order to improve the firmness further, it can be so provided, that the rolled up or the folded end 8 extends over half of the width B of the label 9.

The invention being thus described, it will be apparent that the same may be varied in many ways. Such variations are not to be regarded as a departure from the spirit and scope of the invention, and all such modifications as would be recognized by one skilled in the art are intended to be included within the scope of the following claims.

1-20. (canceled)

21. A method for fabrication of a side fold sack, comprising:
providing a tubular segment made of a fabric of oriented polyolefin material having front and back walls, a bottom end and two sides with side folds, a distance between the side folds on one side to the side folds on the other side defining a length of said front and back walls;
rolling or folding both said front and back walls in said bottom end of said side folded tubular segment across said length at 180° about a bottom fold axis which is essentially transverse to the side folds to form a folded portion;
forming a bond between the material of the folded tubular segment material and at least one wall of the tubular segment that is not folded;
rolling or folding the folded portion upon itself toward said bottom axis about a second axis which also runs essentially transverse to the side folds to form a double-folded bottom part in which an outer side edge of the bottom folded region is linearly aligned with an outer side edge of said sack;
forming a bond between the material of the double-folded bottom part and at least one wall of the tubular segment that is not folded; and
covering at least a part of the double-folded bottom part with a label that is also made of a fabric of oriented polyolefin fibers, said label having a width as measured in a direction transverse to said bottom fold axis less than or equal to a depth of said side folds.

22. The method according to claim 21, wherein said steps of forming a bond between the folded and double-folded tubular segment material, and at least one wall of the tubular segment that is not folded includes forming bonds that are at least partly heat induced.

23. The method according to claim 21, further comprising making a coating on the sack material and bonding said coating with a coating on said label by melting with heat.

24. The method according to claim 21, further comprising forming said label as adhesive bands and placing said label so as to cover only some parts of the double-folded bottom part.

25. A side fold sack made from polyolefin material, comprising:
a sack made from a tubular segment of a fabric of oriented polyolefin material, said sack having front and back walls and side walls that include side folds having a fold depth, said side folds extending parallel with a length of said sack as measured from a top end to a bottom end thereof;
said bottom end of said sack being closed by a first bottom fold made at 180° about a bottom fold axis that extends essentially transversely to the side folds to form a first folded portion and a second fold of said folded portion made inwardly at 180° toward the bottom fold axis about a second axis that is substantially parallel with said bottom fold axis to form a second folded portion that, together with the first folded portion, defines a double-folded bottom part, a length of the double-folded bottom part as measured along the bottom fold axis being the same as a length of the sack as also measured along the bottom fold axis, both said back wall and said front wall extending across the length of the double-folded bottom part in both said first folded portion and said second folded portion; and
a label covering at least a part of the double-folded bottom part adjacent said bottom fold axis and having a width that extends substantially transversely to said bottom fold axis, said label width being less than or equal to the side fold depth, the double-folded bottom part extending under more than half of the label width, the label being joined with one of the front wall or the back wall of the sack by a joint that is heat induced.

26. The side fold sack according to claim 25, wherein the label is joined with at least one wall of the tubular segment and/or with the double-folded bottom part by a joint that is heat induced.

27. The side fold sack according to claim 25, wherein the label is made of a material including coated fabrics made of polyolefin fibers.

28. The side fold sack according to claim 25, wherein the label is formed as adhesive bands.

29. The side fold sack according to claim 28, wherein the label covers only some parts of the double-folded bottom part.

30. The side fold sack according to claim 25, wherein said fabric of oriented polyolefin material has fibers that are monoaxially oriented.

31. The side fold sack according to claim 25, wherein the label joined with the front wall of the sack.

32. The side fold sack according to claim 25, further comprising a coating welded on an outer surface of the sack.

33. The side fold sack according to claim 25, wherein the tubular segment has a longitudinal seam, said bottom fold axis running transversely to said seam.
